(19) United States
(12) Patent Application Publication
(10) Pub. No.: US 2022/0144230 A1
(43) Pub. Date: May 12, 2022

(54) METHOD FOR CONTROLLING A VEHICLE DURING A BRAKING WITH BRAKING FORCES THAT ACT DIFFERENTLY ON RESPECTIVE SIDES OF A STEERABLE VEHICLE AXLE, CONTROL SYSTEM AND VEHICLE

(71) Applicant: ZF CV Systems Europe BV, Brussels (BE)

(72) Inventors: Klaus Plähn, Seelze (DE); Ralph-Carsten Lülfing, Garbsen (DE)

(21) Appl. No.: 17/580,389

(22) Filed: Jan. 20, 2022

Related U.S. Application Data
(63) Continuation of application No. PCT/EP2020/072566, filed on Aug. 12, 2020.

(30) Foreign Application Priority Data
Aug. 15, 2019 (DE) 10 2019 121 969.8

(51) Int. Cl. B60T 8/1764; B60T 8/1755; B62D 6/00; B60W 10/184; B60W 10/20

(52) U.S. Cl. CPC B60T 8/1764; B60T 8/17551; B62D 6/003; B60W 10/184; B60W 2520/28; B60T 2260/024; B60W 2710/20; B60W 2520/14; B60W 2510/18; B60W 10/20

(57) ABSTRACT

A method is disclosed for controlling a vehicle in the event of unexpected braking with braking forces acting differently on respective sides on a steerable vehicle axle. The method includes determining whether there is unintentional braking with the braking forces causing the vehicle to yaw at a braking yaw rate in a yaw direction because of the braking forces. The yaw direction is determined in which the vehicle will yaw as a result of the braking forces. A steering angle requirement is specified and set immediately upon detection of unintentional braking with the different braking forces acting on the respective sides on the steerable vehicle axle with the steering angle requirement being specified in dependence upon the yaw direction so as to cause the braking yaw rate to be compensated on the steerable vehicle axle after setting the steering angle requirement.

### CROSS REFERENCE TO RELATED APPLICATIONS

This application is a continuation application of international patent application PCT/EP2020/072566, filed Aug. 12, 2020 designating the United States and claiming priority from German application 10 2019 121 969.8, filed Aug. 15, 2019, and the entire content of both applications is incorporated herein by reference.

### TECHNICAL FIELD

The disclosure relates to a method for controlling a vehicle during braking with braking forces acting differently on different sides of at least one of the vehicle axles, as well as a control system and a vehicle.

### BACKGROUND

Different braking forces on different sides can occur, for example, when a vehicle brakes on a road with different coefficients of friction on different sides. In this case, a yaw movement of the vehicle in a high-friction direction may occur. This results from the fact that different braking forces act on different sides on the wheels of the vehicle axles in this driving situation. Different brake pressures can be adjusted on different sides by the ABS control system via ABS control valves in order to be able to counteract the locking of individual wheels with these different braking forces on different sides. The brake pressure is thus reduced wheel-specifically by the ABS control valves to varying degrees to the respective slip threshold in order to prevent the respective wheel from locking.

The yaw movement of the vehicle during braking on a road with different coefficients of friction on different sides may be increased by a geometry-dependent steering movement of the steerable vehicle axle, in particular the front axle, wherein the steering movement occurs automatically due to the different braking forces on different sides and is also oriented in the high-friction direction. Overall, the vehicle yaws at a certain braking yaw rate during p split braking, which occurs due to the different braking forces or brake pressures on different sides and the resulting automatic steering movement.

A similar situation can also occur without p split braking if an unintentionally strong deceleration suddenly occurs on one of the front wheels. This may be the case, for example, if one of the ABS control valves or one of the brake cylinders of the wheel brakes on the front wheels, such as a restoring mechanism of the brake cylinder, has a defect. Furthermore, a wheel bearing may also be destroyed. Other defects are also conceivable, which lead to the fact that unexpectedly different braking forces are applied to the steerable front axle on different sides and thus different braking of the vehicle on different sides takes place. Also in such a situation, there is a yaw movement of the vehicle in the appropriate direction, whereby this yaw movement can be amplified by a steering movement of the steerable front axle, wherein the steering movement occurs automatically due to the different braking forces on different sides. In total, in the case of such braking with different braking forces on different sides on the front axle, the vehicle yaws with a certain braking yaw rate, which occurs due to the different braking forces or brake pressures on different sides and the resulting automatic steering movement.

In order to keep the vehicle in its lane in the above situations and to avoid subsequent instability, the resulting braking yaw rate must be fully counteracted with an appropriate steering intervention by the driver, so that the actual yaw rate of the vehicle is adjusted to a target yaw rate acting on the axle before braking with different braking forces on different sides on the axle. Usually, drivers are overwhelmed in such unexpected situations because they rarely occur. Counter steering at high vehicle speeds requires immediate and sufficient steering intervention to keep the vehicle in its lane. Most people, however, react with a very long reaction time and/or insufficiently, so that leaving the lane is highly likely. As a result, the surrounding traffic and also the subject vehicle are endangered.

Conventional automated stability control systems with sole access to the service brake cannot counteract the resulting braking yaw rate in the above situations because they cannot distinguish the steering movement of the steering axle of the vehicle which results from braking with different braking forces on different sides from a steering angle specified by the driver. The stability control system thus compares the actual yaw rate or the braking yaw rate resulting from braking with the target yaw rate to be expected due to the currently adjusted steering angle and determines that they match. As a result, an unstable state is not detected and automated intervention is not carried out.

In order to counteract this, DE 10 2007 038 575 B4 describes that when an understeer process or an oversteer process is detected or the beginning of an understeer process or an oversteer process is detected, the steering angle of the steerable vehicle axle is increased or reduced in order to counteract the braking yaw rate resulting from the braking via steering intervention.

US 2014/0365078 provides that in the event of a detected tendency to tilting of a vehicle as a result of which brakes are controlled side-specifically, the steering angle of a steered vehicle axle is also increased or reduced in order to counteract oversteer or understeer resulting from the side-specific brake control.

However, the disadvantage of both steering interventions is that intervention is only carried out when the vehicle is already in an unstable condition. Depending on the vehicle speed, however, this may already be too late, so that the vehicle has already left its lane and instability may no longer be prevented, as the vehicle can no longer be brought under control without endangering the surrounding traffic or the subject vehicle.

### SUMMARY

An object of the disclosure is therefore to specify a method for controlling a vehicle with which safety-critical situations can be avoided during braking with different braking forces on different sides. The object is further to provide a control system and a vehicle.

According to the disclosure, it is therefore provided that for controlling a vehicle in the event of unexpected braking with braking forces acting differently on different sides on a steerable vehicle axle to first determine whether unintentional braking is occurring with braking forces acting differently on different sides on the steerable vehicle axle, wherein the vehicle yaws with a braking yaw rate in a yaw direction due to the braking forces acting differently on different sides on the steerable vehicle axle, and then to determine the yaw direction in which the vehicle will yaw due to the braking forces acting differently on different sides. Furthermore a steering angle requirement will be specified and set as soon as or immediately after unintentional braking has been detected on the steerable vehicle axle with braking forces acting differently on different sides, wherein the steering angle requirement is specified depending on the determined yaw direction in such a way that the braking yaw rate is compensated after an adjustment of the steering angle requirement on the steerable vehicle axle.

Advantageously, there is thus already an automatic intervention if unintentional or unexpected braking with braking forces acting differently on different sides on the steerable vehicle axle has been detected, and this occurs immediately afterwards and regardless of how strong the resulting braking yaw rate is and whether there is an unstable driving condition. Thus, in the event of detected unexpected or unintentional braking, counter steering can be performed at the same time as the development of the different braking forces on different sides in order to immediately counteract or compensate for the braking yaw rate. Leaving the lane and any unstable driving condition that follows can therefore be prevented from the outset, since a steering intervention occurs even with small yaw movements of the vehicle as a result of unintentional or unexpected braking with different braking forces on different sides, so that leaving a lane and instabilities cannot develop in the first place. Swerving by the vehicle or an exit from the lane as a result of oversteer or understeer can therefore no longer occur, since no intervention is made as in the prior art until an instability has been detected and this is therefore already present.

An unexpected or unintentional braking with different braking forces on different sides is understood as braking in which unexpectedly one-sided braking forces are suddenly induced due to unintended influences to which the driver has not adjusted. These can occur due to active brake intervention, for example in the case of p split braking on a road with different coefficients of friction or, with or without active braking intervention, also due to a defect or failure of a component of the vehicle that influences the braking force on specific wheels of the steerable vehicle axle.

Accordingly, unexpected or unintentional braking may occur due to a defect or a failure of at least one of the ABS control valves assigned to the braked wheels of the steerable vehicle axle or the wheel brakes and/or due to a defect or failure of at least one wheel bearing of the braked wheels of the steerable vehicle axle. However, other components are also conceivable which, due to a defect or failure, can have a wheel-specific influence on the braking force on the steerable vehicle axle.

Such a defect or failure or p split braking causes the vehicle to yaw at a certain braking yaw rate to which the driver cannot adjust, with the yaw aligned in each case in the direction of the higher braking force. At the same time, due to the different braking forces on the steerable vehicle axle on different sides, a steering angle of the steerable vehicle axle in the yaw direction is also adjusted, which further intensifies the effect.

Preferably, it is provided here that unintentional braking with braking forces acting differently on different sides on the steerable front axle is detected. Preferably, however, a different steerable vehicle axle is also conceivable.

In the event of a defect or a failure, unintentional braking with different braking forces acting on the steerable vehicle axle on different sides can be detected even without the presence of a braking requirement. Normally, however, it is only checked whether unintentional braking occurs with different braking forces on different sides if there is a braking requirement.

According to a preferred embodiment, it is provided that the steering angle requirement on the steerable vehicle axle in the context of a steering control is specified and adjusted in such a way that a currently present actual yaw rate approximates to a specified target yaw rate, in particular until the actual yaw rate corresponds to the specified target yaw rate. Thus, advantageously, such a steering angle requirement is specified, by which the vehicle is kept in the lane, wherein in the event of the occurrence of a braking yaw rate and thus an unintentional braking with different braking forces on different sides, a corresponding steering angle requirement is immediately output and set, by which the actual yaw rate in the direction of the target yaw rate is regulated.

The adjustment can be done in the manner of a PI controller, so that rapid but also smooth automated steering takes place.

According to a preferred further embodiment, it is provided here that the target yaw rate is derived from an actual yaw rate which is present in the vehicle before unexpected braking with braking forces acting differently on different sides on the steerable vehicle axle was detected. Thus, steering movements present before unintentional braking, for example cornering, can be assumed in a simple manner as the initial state, to which regulation is carried out according to the disclosure in the event of unintentional braking.

Preferably, it is also provided that the determination of whether unexpected braking with braking forces acting differently on different sides on a steerable vehicle axle is present
is carried out depending on a brake pressure difference between brake pressures on the wheels of the steerable axle braked differently on different sides and/or
is carried out depending on a wheel revolution rate difference between wheel revolution rates on the wheels of the steerable axle braked differently on different sides and/or
is carried out depending on a wheel speed difference between wheel speeds on the wheels of the steerable vehicle axle braked differently on different sides. Thus, it is possible to easily determine whether unintentional braking is present on the basis of measured variables already detected in the vehicle, wherein the brake pressure difference and the wheel revolution rate difference and the wheel speed difference are accurate and up-to-date indicators of the presence of unintentional braking.

Preferably, it may be provided that unexpected braking with braking forces acting differently on different sides on a single vehicle axle is concluded if the brake pressure difference exceeds a maximum brake pressure difference and/or the wheel revolution rate difference exceeds a maximum wheel revolution rate difference and/or the wheel speed difference exceeds a maximum wheel speed difference. As a result, the time of intervention can be precisely determined and, under certain circumstances, a corresponding difference can also be allowed, which is non-critical in normal driving situations.

According to a further embodiment, it is provided that the determination of the yaw direction is also carried out depending on the brake pressure difference and/or the wheel revolution rate difference and/or the wheel speed difference. The direction of the yaw movement of the vehicle as a result of unintentional braking can be easily detected and advantageously also predicted depending on the sign of these differences. This is because the direction in which the vehicle will begin to yaw if no steering intervention is made can be immediately detected on the basis of the brake pressure difference that arises due to the different braking forces, or even the other differences. As a result, counter steering can be performed at the same time as the brake pressure difference is building up, even before a braking yaw rate has built up. Thus, it is possible to react even faster.

According to a preferred further embodiment, the brake pressure difference can be estimated from ABS control signals with functioning ABS control valves, wherein the brake pressures controlled at the wheel brakes via the ABS control valves are side-specifically adjusted depending on the ABS control signals to form a brake pressure difference, and/or the wheel speed difference and/or the wheel revolution rate difference is/are determined from wheel revolution rates determined and output via wheel revolution rate sensors on the individual wheels.

Thus, the brake pressure information and the wheel revolution rate information can be easily accessed without the use of additional sensors. The brake pressure information can be estimated from a specified input pressure on the ABS control valves and activation times of the respective ABS control valves, which are used to maintain the brake pressure or reduce the brake pressure. Therefore if there is a low coefficient of friction, the respective ABS control valve must intervene more frequently to prevent locking than an ABS control valve on the side with the high coefficient of friction, from which the brake pressure and from this a brake pressure difference between the wheels of a vehicle axle can be concluded.

Preferably, it is also provided that the steering angle requirement is automatically implemented via an electrically controllable steering system on a steerable driving axle, preferably the front axle. Thus, the fast reaction times of an automated steering system can be used to control the vehicle in the event of unintentional and unexpected braking.

Preferably, it is further provided that the steering angle requirement is specified depending on the tires of the vehicle and/or road surface conditions and/or an axle load and/or a track width and a scrub radius of the steerable vehicle axle and/or a driving speed. Thus, advantageously, further criteria can be taken into account which have an effect on the braking behavior on a road with different coefficients of friction and which can thus have an influence on the automated intervention in the steering.

Preferably, it is further provided that the steering angle of the steerable vehicle axle can be adjusted depending on a steering torque applied by a steering wheel, wherein as a result of the applied steering torque a driver yaw rate acts on the vehicle, wherein the applied steering torque is allowed if the acting driver yaw rate is directed against the braking yaw rate and is otherwise suppressed. This also allows manual steering interventions via the steering wheel, provided that these do not cause leaving the lane or instabilities and counteract unintentional or unexpected braking. This can also enable swerving or overtaking during braking if this does not lead to an increase in the braking yaw rate.

The control system according to the disclosure for controlling a vehicle in the event of unexpected braking with braking forces acting differently on different sides on a steerable vehicle axle, with which in particular the method according to the disclosure can be carried out, has an electronically controllable braking system and an electronically controllable steering system for setting a steering angle requirement on a steerable vehicle axle, wherein according to the disclosure it is provided that the control system is configured,
to determine whether unintentional braking with braking forces acting differently on different sides is occurring on a steerable vehicle axle, and the yaw direction in which the vehicle is yawing as a result of the braking forces acting differently on different sides,
to specify a steering angle requirement and to set it via the electronically controllable steering system as soon as unintentional braking with braking forces acting differently on different sides has been detected on the steerable vehicle axle,

wherein the steering angle requirement can be specified depending on the determined yaw direction in such a way that the braking yaw rate can be compensated after setting the steering angle requirement on a steerable vehicle axle.

According to the disclosure, a vehicle with such a control system is also provided.

### BRIEF DESCRIPTION OF THE DRAWINGS

The invention will now be described with reference to the drawings wherein:

FIG. 1 shows a vehicle with an electronically controllable braking system and an electronically controllable steering system; and,

FIG. 2 shows a flow diagram of the method according to the disclosure.

### DESCRIPTION OF THE PREFERRED EMBODIMENTS

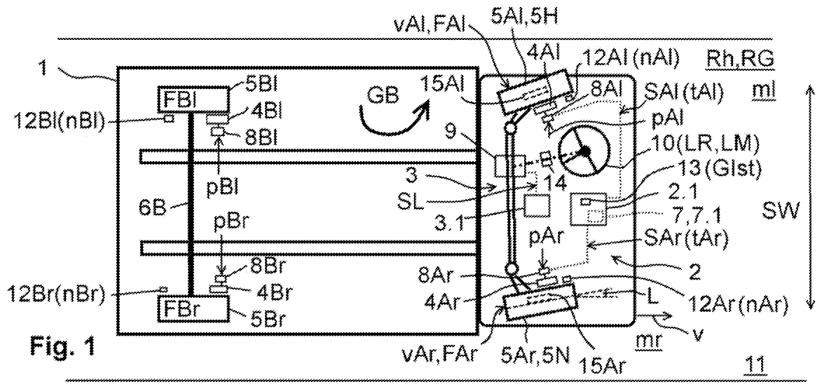

FIG. 1 shows schematically a vehicle 1 with an electronically controllable braking system 2 and an electronically controllable steering system 3, which together form a control system 100 for controlling a vehicle 1 during braking of the vehicle 1 with braking forces FAr, FAl acting differently on different sides, in particular on a front axle 6A of the vehicle 1. The electronically controllable braking system 2 has a brake control device 2.1 of a known type, which can control wheel brakes 4Ar, 4Al, 4Br, 4Bl on the individual wheels 5Ar, 5Al, 5Br, 5Bl of the vehicle axles 6A, 6B wheel-specifically in order to decelerate the vehicle 1 according to a manual or automated braking requirement BV by adjusting certain braking forces FAr, FAl, FAl, FBr, FBl on the respective wheels 5Ar, 5Al, 5Br, 5Bl. The braking is monitored by a stability control system 7, which evaluates the stability of the vehicle 1 and intervenes accordingly to avoid or counteract instability.

A component of the stability control system 7 is in particular an ABS control system 7.1, which monitors the slip value depending on determined wheel revolution rates nAr, nAl, nBr, nBl of the individual wheels 5Ar, 5Al, 5Br, 5Bl and in the event of an imminent locking of one or more wheels 5Ar, 5Al, 5Br, 5Bl adapts the brake pressure pAr, pAl controlled at the wheel brakes 4Ar, 4Al, 4Br, 4Bl, pBr, pBl wheel-specifically via ABS control valves 8Ar, 8Al, 8Br, 8Bl. Via the ABS control valves 8Ar, 8Al, 8Br, 8Bl, the brake pressure pAr, pAl, pBr, pBl can be maintained or reduced, for example, to avoid locking of the wheels 5Ar, 5Al, 5Br, 5Bl. For this purpose, the ABS control valves 8Ar, 8Al, 8Br, 8Bl have inlet valve-outlet valve combinations, for example.

The ABS control valves 8Ar, 8Al, 8Br, 8Bl are controlled wheel-specifically for example by the brake control device 2.1 in certain control cycles via an ABS control signal SAr, SAl, SBr, SBl in order to achieve a pressure retention or a reduction of pressure at the respective wheel brake 4a, 4b. The ABS control logic for the respective vehicle axles 6A, 6B can also be integrated in an electronically controllable axle module which generates the corresponding ABS control signals SAr, SAl, SBr, SBl.

In addition to the braking system 2, the electronically controllable steering system 3 is provided, via which a steering angle L of the wheels 5Ar, 5Al, 5Br, 5Bl of a steerable vehicle axle 6A, 6B, preferably the front axle 6A or another additional axle, can be automatically adjusted via a steering actuator 9. This is described below using the steerable front axle 6A. For this purpose, a steering control device 3.1 is provided, which can specify steering signals SL for the steering actuator 9. Furthermore, the steering angle L of the front wheels 5Ar, 5Al on the front axle 6A can also be manually adjusted by the driver via a steering wheel 10 by applying a certain steering torque LM in a steering direction LR. In this case, the steering of the front axle 6A can be carried out by superposition steering, for example

If the vehicle 1 moves at a certain vehicle speed v on a road 11 with different coefficients of friction ml, mr and in particular the wheel brakes 4Ar, 4Al on the front axle 6A are operated via the braking system 2 as a result of a braking requirement BV, then different braking forces FAr, FAl act on the front wheels 5Ar, 5Al in the event of side-specific ABS control FAr, FAl. The ABS control system 7.1 ensures by different control cycles or by different side-specific ABS control signals SAr, SAl that different brake pressures pAr, pAl are controlled at the wheel brakes 4Ar, 4Al of the front wheels 5Ar, 5Al in order to avoid locking of the front wheels 5Ar, 5Al on the road 11 with the side-specific different coefficients of friction ml, mr. This is also known as p split braking Bmu. The front wheel 5Ar, 5Al which is located on the side of the road 11 with the higher of the two coefficients of friction ml, mR is referred to below as the high coefficient of friction front wheel 5HA and the front wheel 5Ar, 5Al which is located on the side of the road 11 with the lower of the two coefficients of friction ml, mR is referred to below as the low coefficient of friction front wheel 5NA.

Due to the control of different brake pressures pAr, pAl at the wheel brakes 4Ar, 4Al of the front wheels 5Ar, 5Al and the resulting braking forces FAr, FAl acting differently on different sides on the front axle 6A of the vehicle 1, a certain yawing of the vehicle 1 with a braking yaw rate GB is caused, which is in particular dependent on a track width SW of the front axle 6A. The braking yaw rate GB is oriented in a high coefficient of friction direction Rh, that is, the vehicle 1 yaws in the direction of the high coefficient of friction front wheel 5HA; thus in the direction of travel to the left in the example of FIG. 1. At the same time, due to the differently adjusted brake pressures pAr, pAl, such p split braking Bmu also induces a steering movement with a certain steering angle L on the front axle 6A when the front wheels 5Ar, 5Al are braked, wherein the steering movement is also oriented in the high coefficient of friction direction Rh. The induced steering angle L is in particular dependent on a coefficient of friction difference dm=ml−mr, wherein this in turn depends on a brake pressure difference dp=pAl−pAr or a wheel revolution rate difference dn=nAl−nAr. Furthermore, the steering angle L depends on the vehicle geometry, for example a scrub radius.

However, comparable unexpected and unintentional braking situations with different braking forces FAr, FAl on different sides on the steerable front axle 6A can in principle also be present without active brake intervention via the ABS control system 7.1 due to p split braking Bmu. A one-sided strong braking force change on the front axle 6A can also occur, for example, if at least one of the ABS control valves 8Ar, 8Al or one of the wheel brakes 4Ar, 4Al (brake cylinder) assigned to the front wheels 5Ar, 5Al has a defect. This can also unexpectedly result in different brake pressures pAl, pAr or different braking forces FAr, FAl on different sides and therefore different wheel revolution rates nAl, nAr on the front wheels 5Ar, 5Al. Furthermore, as a result of a defect in one of the wheel bearings 15Ar, 15Al of the front wheels 5Ar, 5Al, there may be a one-sided change in the braking forces FAr, FAl on the axle 6A, wherein different wheel revolution rates nAl, nAr are also adjusted on the front wheels 5Ar, 5Al in this situation.

In general, therefore, there may also be an unexpected one-sided change in the braking forces FAr, FAl on the front axle 6A if there is a defect or a failure in a component of the vehicle 1 which influences the braking force FAr, FAl on the front axle 6A (or generally on the steerable vehicle axle). This also causes the vehicle 1 to yaw with a certain braking yaw rate GB, which depends on the track with SW of the front axle 6A and which is oriented in the direction of the higher braking force FAr, FAl on the front axle 6A.

As with p split braking, such a one-sided defect induces a steering movement with a certain steering angle L on the steerable front axle 6A when the front wheels 5Ar, 5Al are braked with different strengths. The steering movement is oriented in the same direction as the yawing of the vehicle with the braking yaw rate GB, that is, in the direction of the higher braking force FAr, FAl on the front axle 6A. The induced steering angle L is in particular dependent on the resulting brake pressure difference dp=pAl−pAr or the wheel revolution rate difference dn=nAl−nAr or a resulting wheel speed difference dv=vAl−vAr between the wheel speeds vAl, vAr of the front wheels 5Al, 5Ar. Furthermore, the steering angle L depends on the vehicle geometry, for example a scrub radius.

In the event of a defect just described or in the case of p split braking Bmu or generally in the case of unintentional or unexpected braking with different forces FAr, FAl on different sides on the steerable front axle 6A, wherein in each case there is a change in the steering angle L, it is necessary that the driver intervenes correctively quickly and sufficiently via the steering wheel 10, in particular to keep in the lane or not to veer off the road, otherwise there may be a danger to the vehicle 1 and the surrounding traffic. In order to relieve the load on the driver, since he is normally not adjusted to such situations and therefore intervenes too late and/or insufficiently, it is provided according to the disclosure to intervene automatically via the steering system 3 via the steering actuator 9, as soon as it is determined that braking with different braking forces FAr, FAl on different sides on the steerable front axle 6A occurs unexpectedly and unintentionally:

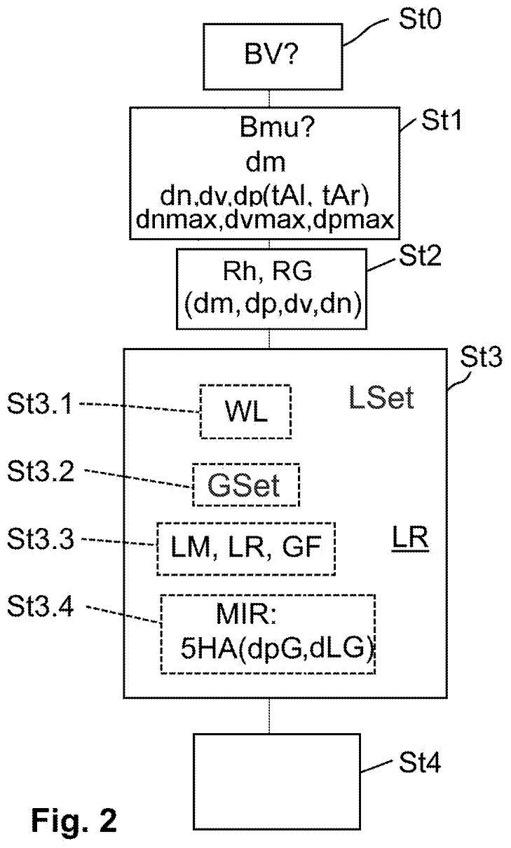

This is carried out in accordance with FIG. 2 by checking in an initial step St0 whether there is a manual or automated braking requirement BV, and in a subsequent first step St1 by checking whether there is unintentional braking with different braking forces FAr, FAl on different sides on the steerable vehicle axle, in this case the front axle 6A. This can be detected, for example, from the brake pressure difference dp=pAl−pAr and/or the wheel revolution rate difference dn=nAl−nAr and/or the wheel speed difference dv=vAl−vAr.

If the brake pressures pAl, pAr on the steerable front axle 6A and thus also the brake pressure difference dp are not determined directly from measurements, these can be estimated, wherein this can be achieved in the case of p split braking Bmu depending on the ABS control signals SAr, Sal, which lead to certain control times tAr, tAl or control cycles of the ABS control valves 8Ar, 8Al on the steerable front axle 6A. From these control times tAr, tAl together with a known input pressure which is supplied to the ABS control valves 8Ar, 8Al, a brake pressure difference dp can at least be estimated, wherein it is to be expected that for the low coefficient of friction front wheel 5NA there will be more frequent control and thus longer control times tAr, tAl of the respective ABS control valve 8Ar, 8Al, since on this low coefficient of friction front wheel 5NA there is to be more frequent intervention to prevent locking than with the high coefficient of friction front wheel 5HA. Thus, from a specified maximum brake pressure difference dpmax, braking with different braking forces on different sides can be concluded. However, this estimation can only be made if the ABS control valves 8Ar, 8Al on the front axle 6A are not defective themselves and the cause of the different braking forces FAr, Fal on different sides.

Another possibility is to determine the wheel revolution rates nAl, nAr or the wheel revolution rate difference dn, which are output directly from wheel revolution rate signals emitted by wheel speed sensors 12Ar, 12Al on the front wheels 5Ar, 5Al. If a certain specified maximum wheel revolution rate difference dnmax in accordance with the currently present braking requirement BV on the steerable vehicle axle or front axle 6A is exceeded, unintentional braking with different braking forces FAr, FAl on different sides on the steerable front axle 6A is concluded. From the wheel revolution rates nAl, nAr or the wheel revolution rate difference dn, the wheel speed difference dv=vAl−vAr can also be alternatively determined, which in turn is compared with a given maximum wheel speed difference dvmax. In the event of exceeding this, it is also possible to conclude unintended braking with different braking forces FAr, FAl on different sides on the steerable front axle 6A.

The determination of whether there is unintentional braking with different braking forces FAr, FAl on different sides on the steerable front axle 6A can be carried out in the brake control device 2.1, in particular also in the stability control system 7 or in the ABS control system 7.1.

In a subsequent second step St2, after establishing that there is unintentional braking with different braking forces FAr, FAl on different sides on the steerable front axle 6A, it is determined in which yaw direction RG this unintentional braking is oriented or in which yaw direction RG the vehicle 1 is expected to yaw with the braking yaw rate GB due to this unintentional braking. This follows, for example, from the sign of the wheel revolution rate difference dn or the brake pressure difference dp or the wheel speed difference dv, since for the front wheel 5Ar, 5Al with the higher braking force FAr, FAl (in the case of p split braking Bmu the high coefficient of friction front wheel 5HA) at least at times a lower brake pressure pAr, pAl or a lower revolution rate nAr, nAl or a lower wheel speed vAr, vAl is to be expected than for the front wheel 5Ar, 5Al with the lower braking force FAr, FAl. Depending on this, the brake pressure difference dp=pAl−pAr or the wheel revolution rate difference dn=nAl−nAr or the wheel speed difference dv=vAl−vAr is positive or negative. Thus, on this basis it can already be predicted in which direction RG the vehicle 1 will yaw or what sign the braking yaw rate GB will have.

Depending on the orientation or the sign of the braking yaw rate GB or the yaw direction RG during unintentional braking with different braking forces FAr, FAl on different sides on the steerable front axle 6A, a steering angle requirement LSet will then be generated in a third step St3 as part of the continuous steering control LG and will be output in the steering signal SL to the steering actuator 9 via the steering control device 3.1. The steering angle requirement LSet is defined in such a way that the braking yaw rate GB is counteracted. That is, the steering angle requirement LSet leads to a steering angle L on the front axle 6A which compensates for the braking yaw rate GB. Thus, at the same time as the unintentional build-up of the different braking forces FAr, FAl on different sides, this can be counter-steered via the steering angle requirement LSet, even before a braking yaw rate GB builds up.

At the beginning of such steering control LG, for example an empirically determined starting value WL for the steering angle requirement LSet can be set in a first sub-step St3.1. Based on this, an actual yaw rate of the vehicle 1 is then continuously monitored in a second sub-step St3.2 and compared with a target yaw rate GSet in order to determine the reaction of the vehicle 1 to the steering angle requirement LSet. As long as there is a deviation between the actual yaw rate GIst and the target yaw rate GSet, the steering angle requirement LSet is further adjusted until the actual yaw rate GIst and the target yaw rate GSet match within a tolerance. The control can be carried out, for example, in the manner of a PI controller, in order to obtain rapid but also “smooth” control without jumps. The actual yaw rate GIst can be provided, for example, by the stability control system 7, which determines it anyway for other stability controls, so that no further sensors are necessary.

The target yaw rate GSet for this steering control LG can be set in such a way that apart from during unintentional braking with different braking forces FAr, FAl on different sides on the steerable front axle 6A, the actual yaw rate GIst of the vehicle 1 is continuously determined and for example stored in a memory device 13. As soon as the existence of unintentional braking with different braking forces FAr, FAl on different sides on the steerable front axle 6A is concluded in the first step St1, the value of the actual yaw rate GIst last stored before this determination is set as the target yaw rate GSet and is used as the basis for the steering control LG. As a result, steering movements originally made by the driver can also be taken into account if the vehicle 1 is for example in a curve or overtaking during such unintentional braking. If the vehicle 1 is located on a straightaway, a target yaw rate GSet of about zero can be assumed.

If the actual yaw rate GIst matches the target yaw rate GSet, the steering requirement LSet is maintained in a fourth step St4, since the braking yaw rate GB is automatically balanced out or compensated by the active steering and the vehicle 1 thus continues in the original lane. Leaving the lane or the road as well as any subsequent instabilities and thus a danger to the subject vehicle 1 and the surrounding traffic can thus be avoided efficiently by this steering control LG.

The described automated steering control LG ensures that a steering intervention via the steering requirement LS should take place immediately when unintentional braking with different braking forces FAr, Fal on different sides is initiated and not only when the vehicle 1 has left the lane and possibly already an instability has already arisen as a result of this. As a result, the corrective steering intervention can be reduced since the braking yaw rate GB is counteracted right at the beginning of its formation and not only when the vehicle 1 leaves the lane or breaks away as a result. The deviation from the original lane can thus be significantly reduced. Due to the electronic control, automated steering can also be carried out with a shorter reaction time than with manual steering, so that the risk of safety-critical effects on the subject vehicle 1 and the surrounding traffic can be minimized.

In a third sub-step 3.3, the steering control LG can also take into account whether the driver subsequently intervenes in the steering, for example in reaction to the unintentional braking with different braking forces FAr, FAl on different sides and/or by initiating a lane change under braking. For this purpose, for example, a force sensor 14, which interacts with a torsion bar of the steering system 3, can be used to determine a steering torque LM applied by the driver via the steering wheel 10. Influence by the steering angle L as a function of this steering torque LM can then be permitted by the steering system 3 if a driver yaw rate GF is acting on the vehicle 1 through the steering torque LM, which is directed against the braking yaw rate and compensates for this as well as the automated steering requirement LSet. Thus, if the driver specifies manual steering in a steering direction LR which corresponds to the steering direction LR of the steering actuator 9, this is permitted. However, if the driver steers in the opposite steering direction LR, that is, the driver's yaw rate GF amplifies the braking yaw rate GB, implementation by the steering system 3 can be prevented in order not to risk instabilities or lane departure.

In addition, in a fourth sub-step St3.4 in the presence of p split braking Bmue as unintentional braking with different braking forces FAr, FAl on different sides, it may be provided that an adjustment of the ABS brake control takes place in the ABS control system 7.1, thereby shortening a braking distance of the vehicle 1 during p split braking Bmu. ABS brake control can normally be carried out during p split braking Bmu according to a modified individual control (MIR). For this purpose, when p split braking Bmu is detected, the brake pressure pAr, pAl on the high coefficient of friction front wheel 5HA is first reduced to the brake pressure pAR, pAl which is adjusted on the low coefficient of friction front wheel 5NA, so that a braking yaw rate GB of zero is present. In order not to lose any braking force as a result, the brake pressure pAr, pAl on the high coefficient of friction front wheel 5HA is then slowly increased again to the slip threshold with a pressure build-up gradient dpG. The pressure build-up gradient dpG is normally defined in such a way that the driver has the opportunity to react to the resulting braking yaw rate GB.

However, since automated steering control LG is carried out via the steering actuator 9 according to the steps St3, St3.1, St3.2, St3.3 in the steering control LG according to the disclosure, it can be assumed that a very fast and sufficient reaction to a pressure increase on the high coefficient of friction front wheel 5HA can take place within the framework of the MIR. As a result, the pressure build-up gradient dpG can be increased accordingly, as the resulting rapidly increasing braking yaw rate GB can also be reacted to quickly via the steering actuator 9 with a matched steering gradient dLG. As a result, the braking distance can be shortened compared to a normal MIR, as the brake pressure pAr, pAl on the high coefficient of friction front wheel 5HA can be raised again faster. At the same time, the rapid and automated adjustment of the steering angle L with a correspondingly high steering gradient dLG can keep the vehicle 1 in the lane, resulting in a combinatorial effect compared to the prior art.

In addition, it may generally be provided in the context of the steering control LG that the steering angle requirement LSet is determined depending on further criteria, wherein, for example, the axle load KL on the respective vehicle axle 6A, 6B, the selection of the tires KB used, a track width SW and a scrub radius of the front axle 6A, the vehicle speed v and a road condition KF of the road 11 can be used as criteria.

The method just described for controlling the vehicle 1 via the control system 100 can be carried out in the brake control device 2.1 of the braking system 2, in particular as part of the stability control system 7. For this purpose, the stability control system 7 can be extended accordingly on the software and/or hardware side. The brake control device 2.1 already has available a large part of the parameters used via a CAN bus in the vehicle 1 and a connection to an electric steering system 3 may already be available, so that only minor adjustments are necessary.

It is understood that the foregoing description is that of the preferred embodiments of the invention and that various changes and modifications may be made thereto without departing from the spirit and scope of the invention as defined in the appended claims.

### REFERENCE CHARACTER LIST (PART OF THE DESCRIPTION)

1 vehicle
2 electronically controllable braking system
2.1 brake control device
3 electronically controllable steering system
3.1 steering control device
4Ar, 4Al wheel brakes of the front axle (right, left)
4Br, 4Bl wheel brakes of the rear axle (right, left)
5Ar, 5Al front wheels (right, left)
5Br, 5Bl rear wheels (right, left)
5HA high coefficient of friction front wheel
5NA low coefficient of friction front wheel
6A front axle
6B rear axle
7 stability control system
7.1 ABS control system
8Ar, 8Al ABS control valves on the front axle
8Br, 8Bl ABS control valves on the rear axle
9 steering actuator
10 steering wheel
11 road
12Ar, 12Al wheel revolution rate sensors on the front wheels
12Br, 12Bl wheel revolution rate sensors on the rear wheels
13 memory device
14 force sensor
15Ar, 15Al wheel bearings of the front wheels 5Ar, 5Al
100 control system
Bmu μ split braking
BV braking requirement
dLG steering gradient
dm coefficient of friction difference
do wheel revolution rate difference
dnmax maximum wheel revolution rate difference
dp brake pressure difference
dpmax maximum brake pressure difference
dpG pressure build-up gradient
dv wheel speed difference
dvmax maximum wheel speed difference
FAr, FAl braking force at the front wheels
FBr, FBl braking force at the rear wheels
GB braking yaw rate
GF driver yaw rate
GIst actual yaw rate
GSet target yaw rate
KB tires
KF road surface conditions
KL axle load
L steering angle
LG steering control
LM steering torque
LR steering direction
LSet steering angle requirement
mr, ml road coefficients of friction (right, left)
nAr, nAl wheel revolution rates of the front wheels (right, left)
nBr, nBl wheel revolution rates of the rear wheels (right, left)
pAr, pAl brake pressure on the front wheels (right, left)
pBr, pBl brake pressure on the rear wheels (right, left)
RG yaw direction
Rh high coefficient of friction direction
SAr, SAl ABS control signals on the front axle (right, left)
SBr, SBl ABS control signals on the rear axle (right, left)
SL steering signal
SW track width
tAr, tAl control times of the ABS control valves
v vehicle speed
vAr, vAl wheel speed of the front wheels (right, left)
WL starting value for the steering angle requirement LSet

What is claimed is:

1. A method for controlling a vehicle in the event of unexpected braking with braking forces (FAr, FAl) acting differently on respective sides on a steerable vehicle axle, the method comprising at least the steps of:
determining whether there is unintentional braking with said braking forces (FAr, FAl) acting differently on said respective sides on said steerable vehicle axle causing said vehicle to yaw at a braking yaw rate (GB) in a yaw direction (RG) because of said braking forces (FAr, FAl) acting differently on said respective sides on the steerable vehicle axle;
determining said yaw direction (RG) in which said vehicle will yaw as a result of said braking forces (FAr, FAl) acting differently on said respective sides;
specifying and setting a steering angle requirement (LSet) immediately upon detection of unintentional braking with said different braking forces (FAr, FAl) acting on said respective sides on said steerable vehicle axle with said steering angle requirement (LSet) being specified in dependence upon said yaw direction (RG) so as to cause said braking yaw rate (GB) to be compensated on said steerable vehicle axle after setting said steering angle requirement (LSet).

2. The method of claim 1, wherein an unintentional braking with braking forces (FAr, FAl) acting differently on said respective sides on said steerable front axle is determined.

3. The method of claim 1, wherein an unintentional braking with said braking forces (FAr, FAl) acting differently on said respective sides on said steerable vehicle axle is determined only in the presence of a braking specification (BV).

4. The method of claim 1, wherein said steering angle requirement (LSet) on said steerable vehicle axle is specified and set in the context of a steering control (LG) in such a way that a currently present actual yaw rate (GIst) approximates to a specified target yaw rate (GSet) until the actual yaw rate (GIst) corresponds to the specified target yaw rate (GSet).

5. The method of claim 4, wherein said target yaw rate (GSet) is derived from an actual yaw rate (GIst) present in said vehicle before said unexpected braking with said braking forces (FAr, FAl) acting differently on said respective sides on said steerable vehicle axle was determined.

6. The method of claim 1, wherein the determination of whether said unexpected braking with braking forces (FAr, FAl) acting differently on respective sides on said steerable vehicle axle is present is carried out depending on at least one of the following:
a) a brake pressure difference (dp) between brake pressures (pAr, pAl) on wheels of the steerable vehicle axle which are braked differently on said respective sides;
b) a wheel revolution rate difference (dn) between wheel revolution rates (nAr, nAl) on the wheels of said steerable vehicle axle which are braked differently on said respective sides; and,
c) a wheel speed difference (dv) between wheel speeds (vAr, vAl) on the wheels of said steerable vehicle axle which are braked differently on said respective sides.

7. The method of claim 6, wherein said unexpected braking with braking forces (FAr, FAl) acting differently on said respective sides on said steerable vehicle axle is concluded when at least one of the following is present:
a) the brake pressure difference (dp) exceeds a maximum brake pressure difference (dpmax);
b) the wheel revolution rate difference (dn) exceeds a maximum wheel revolution rate difference (dnmax); and,
c) the wheel speed difference (dv) exceeds a maximum wheel speed difference (dvmax).

8. The method of claim 6, wherein the determination of the yaw direction (RG) is carried out in dependence upon at least one of the following:
a) the brake pressure difference (dp); and,
b) the wheel revolution rate difference (dn); and,
c) the wheel speed difference (dv).

9. The method of claim 6, wherein said brake pressure difference (dp) is estimated from ABS control signals (SAr, SAl, SBr, SBl), wherein brake pressures (pAr, pAl, pBr, pBl) controlled at the wheel brakes are side-specifically adapted by ABS control valves depending on the ABS control signals (SAr, SAl, SBr, SBl) to form at least one of the following:
a) brake pressure difference (dp);
b) said wheel revolution rate difference (dn); and,
c) said wheel speed difference (dv) determined from wheel revolution rates (nAr, nAl, nBr, nBl) determined and outputted by wheel revolution rate sensors on respective individual wheels.

10. The method of claim 1, wherein said steering angle requirement (LSet) is automatically implemented on said steerable vehicle axle by an electrically controllable steering system.

11. The method of claim 1, wherein said steering angle requirement (LSet) is specified depending on at least one of the following:
a) the tires (KB) of the vehicle;
b) a road condition (KF);
c) an axle load (KL);
d) a track width (SW) of said steerable vehicle axle; and,
e) a vehicle speed (v).

12. The method of claim 1, wherein a steering angle (L) of said steerable vehicle axle can be adjusted depending on a steering torque (LM) applied by a steering wheel, wherein, as a result of the applied steering torque (LM), a driver yaw rate (GF) acts on said vehicle, wherein the applied steering torque (LM) is allowed when the acting driver yaw rate (GF) counteracts the braking yaw rate (GB) and otherwise is suppressed.

13. The method of claim 1, wherein said unexpected braking with said braking forces (FAr, FAl) acting differently on said respective sides on said steerable vehicle axle is present due to at least one of the following:
a) split braking (Bmu);
b) defect or failure of at least one of ABS control valves or wheel brakes assigned to the braked wheels of said steerable vehicle axle;
c) a defect or failure of at least one wheel bearing of the braked wheels of said steerable vehicle axle; and,
d) a defect or failure of a component of said vehicle which individually affects said braking force (FAr, FAl) on said steerable vehicle axle.

14. A control system for controlling a vehicle having a steerable vehicle axle, an electronically controllable brake system and an electronically controllable steering system for setting a steering angle required (LSet) on the steerable vehicle axle, the control system being provided for controlling the vehicle in the event of unexpected braking with braking forces (FAr, FAl) acting differently on respective sides on the steerable vehicle axle, said control system comprising a configuration to do the following:
to determine whether said unintentional braking with braking forces (FAr, FAl) acting differently on said respective sides on said steerable vehicle axle is present and to determine the yaw direction (RG) in which said vehicle yaws as a result of said braking forces (FAr, FAl) acting differently on said respective sides;
to specify said steering angle requirement (LSet) and to adjust said steering angle requirement (LSet) via said electronically controllable steering system as soon as said unintentional braking with braking forces (FAr, FAl) acting differently on said respective sides on said steerable vehicle axle has been determined; and,
wherein said steering angle requirement (LSet) can be specified depending on the determined yaw direction (RG) so as to cause a braking yaw rate (GB) to be compensated on said steerable vehicle axle after an adjustment of said steering angle requirement (LSet).

15. A vehicle comprising:
a steerable vehicle axle;
an electronically controllable brake system;
an electronically controllable steering system for setting a steering angle required (LSet) on said steerable vehicle axle;
a control system for controlling said vehicle in the event of an unexpected braking with braking forces (FAr, FAl) acting differently on respective sides on said steerable vehicle axle; and,
said control system being configured to do the following:
to determine whether said unintentional braking with braking forces (FAr, FAl) acting differently on said respective sides on said steerable vehicle axle is present and to determine the yaw direction (RG) in which said vehicle yaws as a result of said braking forces (FAr, FAl) acting differently on said respective sides;
to specify said steering angle requirement (LSet) and to adjust said steering angle requirement (LSet) via said electronically controllable steering system as soon as said unintentional braking with braking forces (FAr, FAl) acting differently on said respective sides on said steerable vehicle axle has been determined; and,
wherein said steering angle requirement (LSet) can be specified depending on the determined yaw direction (RG) so as to cause a braking yaw rate (GB) to be compensated on said steerable vehicle axle after an adjustment of said steering angle requirement (LSet).
